(19) United States
(12) Patent Application Publication
(10) Pub. No.: US 2002/0005597 A1
(43) Pub. Date: Jan. 17, 2002

(54) Dry recycle process for recovering UO2 scrap material

(75) Inventors: Richard I. Larson, Wilmington, DE (US); James W. Summey, Wrightsville Beach, NC (US)

Correspondence Address: NIXON & VANDERHYE P.C., 8th Floor, 1100 North Glebe Road, Arlington, VA, 22201-4714, US

(73) Assignee: General Electric Company

(21) Appl. No.: 09/915,407

(22) Filed: Jul. 27, 2001

Related U.S. Application Data
(63) Continuation of application No. 09/764,298, filed on Jan. 19, 2001.

(51) Int. Cl. G21C 21/00; B28B 1/00

(52) U.S. Cl. 264/.5; 376/411; 264/643

(57) ABSTRACT

A process for producing high sinter density UO₂ powder from UO₂-containing scrap powder material, wherein the scrap material is oxidized at low temperature and the resulting U₃O₈ powder is reduced at a higher temperature which is than about to 800° C. to produce UO₂ having high sinter density and high surface area.

The present invention relates generally to the production of fissionable nuclear fuel comprising oxides of enriched uranium for use in nuclear reactors. More particularly, the invention describes a dry recycle process for reclaiming UO₂ scrap material.

### BACKGROUND OF THE INVENTION

Fissionable fuel grade uranium oxides for service in power generating nuclear reactors are commonly produced from uranium hexafluoride. Generally, uranium hexafluoride is converted to uranium oxides for reactor fuel using a “wet process” in which the conversion reactions are carried out within an aqueous medium or liquid phase with the reactants in solution and/or as a solid suspension therein. Typically, this wet process comprises hydrolyzing uranium hexafluoride (UF₆) in water to form the hydrolysis product uranyl fluoride (UO₂F₂), adding ammonium hydroxide to the uranyl fluoride to precipitate the uranyl fluoride as solid ammonium diuranate ((NH₄)₂U₂O₇). The precipitate is dewatered and calcined in a reducing atmosphere to produce an oxide of uranium (e.g. UO₂). This version of the wet process is frequently referred to as the “ADU” procedure, since it normally entails the formation of ammonium diuranate.

The uranium oxides commercially produced by such conventional methods comprise a fine relatively porous powder which is not suitable for use as such as fuel in a nuclear reactor. Typically, it is not a free-flowing relatively uniform-sized powder, but rather clumps and agglomerates to form particles of varying sizes, making it unsuitable to uniformly pack into units of an appropriate and consistent density. In view of this, the raw uranium oxide product derived from the chemical conversion process is normally processed through conventional powder refining procedures, such as milling and particle classification to provide an appropriate sizing of the powders. Such processing frequently includes blending of uranium oxide powders of different particle sizes or ranges and from different sources. The resulting processed powders are then press-molded into “green” or unfired pellets, which are subsequently sintered to fuse the discrete powder particles thereof into an integrated body having a unit density of 95-97% of theoretical (“TD”) of the oxide of uranium. These pellets are more suitable for utilization in the fuel system of a nuclear reactor.

During the foregoing chemical conversion process, UO₂ scrap materials such as sintered pellets, grinder swarf, press scrap, and calciner powder are produced. These materials are conventionally recycled. Usually, scrap UO₂ materials from the production facility are oxidized in a high-temperature furnace to produce U₃O₈, which is then reacted with nitric acid to produce uranyl nitrate solutions. ADU is precipitated from these solutions by addition of ammonium hydroxide. The ADU precipitate may or may not be dried before processing through the calciner in a hydrogen-reducing environment to produce UO₂ powder. This UO₂ powder has a low sinter density, generally less than 10.60 gm/cm³ or 96.6% TD. In addition, sintered pellets produced from this UO₂ powder have a high open porosity, non-uniform microstructure and poor production yields, i.e. radial cracks and end flakes.

The prior nitric acid process suffers from the disadvantages that a plurality of steps are involved, along with difficult handling operations, such as dissolution of U₃O₈ in nitric acid following oxidation of UO₂, precipitation with ammonium hydroxide to form ADU, centrifugation and clarification and handling of wet sludge and liquid waste streams. There is a need for a simpler and less expensive process for recycling material, in particular rejected UO₂ sintered material, grinder swarf, press scrap and calciner powder. The present invention seeks to fill that need.

### SUMMARY OF THE INVENTION

The present inventors have now discovered that it is possible to simplify the recycling and production of UO₂ without dissolving UO₂ in nitric acid. It is possible according to the present invention to produce high density UO₂ from scrap uranium-containing material at lower temperatures and under substantially dry conditions. The resulting high sinter density UO₂ may be used directly in the fabrication of fuel pellets or may be mixed with virgin UO₂ to adjust the isotopic content of the mixture to a desired level.

In accordance with one aspect in the present invention, there is provided a process for producing high sinter density UO₂ powder from uranium-containing scrap powder material, comprising oxidizing the uranium-containing scrap powder at low temperatures to produce U₃O₈, and reducing the resulting U₃O₈ to produce UO₂ powder with high sinter density and high surface area.

In accordance with another aspect, the invention provides high sinter density UO₂ produced by the process of the invention.

In accordance with a yet further aspect, there is provided a fuel pellet fabricated from high sinter density UO₂ obtained according to the process of the invention.

In accordance with another aspect of the present invention, there is provided a composition comprising virgin UO₂ and UO₂ powder produced according to the process of the invention.

In accordance with a yet another aspect of the present invention, there is provided a fuel pellet produced using UO₂ powder obtained according to the present process, and/or produced using a composition of the invention comprising UO₂ admixed with virgin UO₂.

The present invention provides a simpler and less expensive dry process for producing high sinter density UO₂ powder which meets sinter density, densification and porosity requirements for use in boiling water reactors. A uniform microstructure is also obtained.

### BRIEF DESCRIPTION OF THE DRAWINGS

The invention will now be described in more detail with respect to the accompanying drawings, in which:

FIG. 1 is a process flow diagram of the process of the invention;

FIG. 2 shows the sintering characteristics of U₃O₈; and

FIGS. 3A-C show the pellet results obtained using UO₂ produced according to the present invention.

### BEST MODE FOR CARRYING OUT THE INVENTION

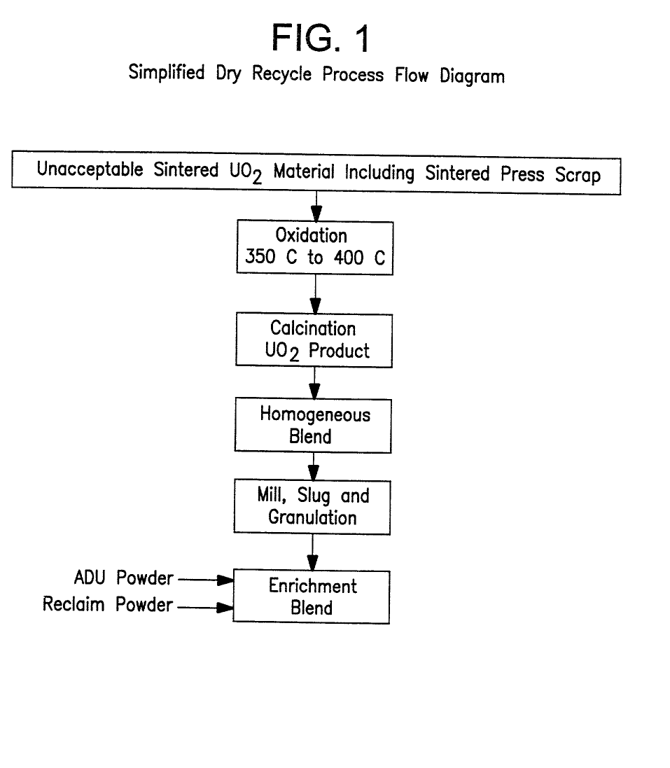

The process of the invention is generally described in FIG. 1. In the first step, uranium-containing scrap material is oxidized to form U₃O₈. The term “uranium-containing scrap material” as used herein means uranium-containing material, most usually in the form of UO₂, obtained from rejected sintered pellets, i.e. pellets not suitable for use in fuel cladding, grinder swarf (dust generated by a sintered pellet grinder), press scrap and calciner powder. Typically, the uranium-containing scrap material is in powder form and has a surface area ranging from about 5.0-6.5 m²/gm, typically 5.2-6.0 m²/gm. The sinter density of the rejected material is generally in the region of 96.5 to 98.5% TD, and typically averages about 97.3% TD.

The oxidation step is generally performed in a conventional production furnace using boats that are pushed through the furnace according to ways well known in the art, or a rotary calciner/kiln, or a laboratory furnace, at low temperature. Optimally, a rotary calciner/kiln is employed because of the mixing mechanism of the material (via baffles inside the heating chamber) and uniformity of the radial temperature (i.e. temperature through the bed of powder). The temperature distribution in the production furnace is generally not as uniform and the material is not as well mixed throughout the gas stream, resulting in less uniform oxidation.

The term “low temperature” as used herein in connection with the oxidation step means a temperature which is high enough to achieve oxidation of the material without giving rise to sintering of the material. The “low temperature” is typically in the range of 300-500° C., more usually less than about 400° C., for example about 300° C. to 380° C.

Calcination includes a hydrogen reduction step, wherein hydrogen gas is passed over the oxidized material to produce reduced UO₂. The calcination may be carried out in the same furnace as used for the oxidation or in a different furnace Calcination is typically carried out at temperatures higher than those used in the oxidation step, i.e. less than 800° C., more usually about 600° C. to 725° C.

Calcination is followed by a “homogeneous blend” step wherein the enrichment of the reduced UO₂ is determined. The isotopic content is determined using conventional techniques known to persons skilled in this art. The desired uranium content may be achieved by addition of virgin UO₂, ADU powder or additional reclaimed powder.

A “mill slug and granulation” step then typically performed according to conventional procedures. Optionally, a further enrichment blend is carried out to achieve the desired uranium level by the addition of ADU powder or reclaimed UO₂ powder.

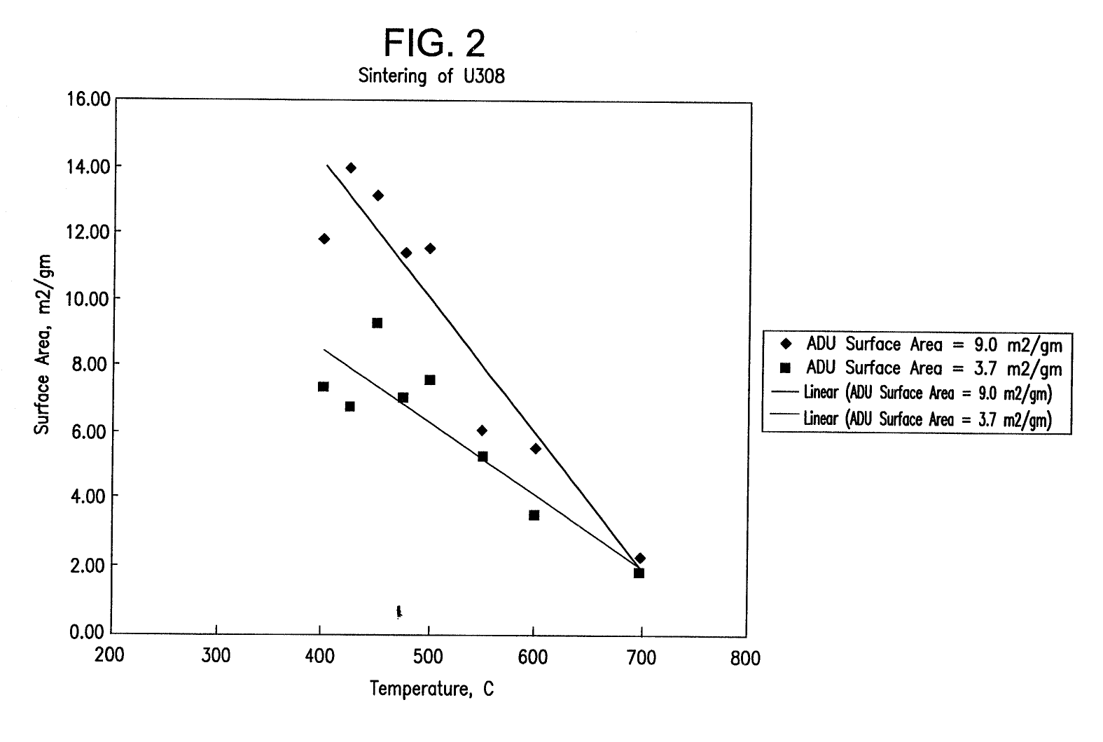

FIG. 2 shows the sintering characteristics of U₃O₈ after 1 hour of exposure at each temperature. As the temperature increases from 400-700° C., the specific surface area of the U₃O₈ decreases from values in the region of 7-14 m²/gm to 2 m²/gm. Between 350 and 380° C., the amount of U₃O₈ sintering is small, as indicated by the high surface area measurements (7-14 m²/gm). Within this low temperature range (350-380° C. ), sintering is a function of the particle size of the ADU starting material At 700° C., the basic U₃O₈ particle size has increased, as indicated by the low specific area measurements (2 m² /gm). At high temperatures, the particle size effect of the ADU starting material is not observed. Because the hydrogen reduction process occurs at temperatures below 800° C., UO₂ sintering does not occur in the present process.

The U₃O₈ produced according to the first step of the process is substantially free of sintered product. As used herein, the term “substantially free” as used in connection with the absence of sintered product in the U₃O₈ and/or the UO₂ means that the product contains less than 5 wt % of sintered product, generally less than 1 wt %, more usually 0.05-01 wt %.

The oxidation step is carried out by passing air or oxygen though the furnace or calciner and in contact with the uranium-containing scrap material. Generally the air/oxygen flow is in the region of 5 cc/min to 15 cc/min, more usually about 10 cc/min.

The low temperature oxidation step results in the formation of U₃O₈ powder having a surface area generally in the range of about 5.8-7.5 m²/gm, more usually about 6.2-7.0 m²/gm. The increase in the surface area of the U₃O₈ over that of the starting UO₂ (which is typically about 5-6.5 m²/gm) is due to the different crystal structure of the U₃O₈.

The reduction (calcination) step may be carried out in the same furnace or in a different furnace. Reduction is carried out by passing hydrogen gas through the furnace and into contact with the heated U₃O₈. The hydrogen gas may optionally be mixed with nitrogen for safety reasons. The hydrogen flow rate through the calciner is typically in the region of 225 to 490 scfh, usually about 300 scfh. The nitrogen flow is usually set at a rate that provides about 50 volume percent.

The reduction is carried out at a higher temperature than the oxidation step. The expression “higher temperature” as used herein in connection with the reduction step means a temperature which is high enough to obtain reduction of the U₃O₈ but not sufficiently high to cause sintering of the resulting UO₂. UO₂ sinters in the region of 800° C. The higher temperature used in the reduction step is generally less than 800° C., more usually in the region of 600-725° C. The resulting UO₂ is substantially free of UO₂ sintered product. Some particle fusion is observed due to U₃O₈ sintering.

Reduction of the U₃O₈ produces high sinter density UO₂ powder having a lower surface area than the starting UO₂. Generally, the surface area of the resulting UO₂ is in the range of 3.5 and 5 m²/gm, more usually 3.5 to 4.5 m²/gm, for example 4.4 to 4.6 m²/gm. The sinter density of the high density UO₂ ranges from about 98.4 to 99.0% TD, and typically averages about 98.6% TD.

Examples of surface areas obtained according to the present invention using two calciners (calciners 1 and 2) are set forth below in Tables 1A and 1B.

TABLE 1A
Calciner 1

| Rejected UO₂ Powder | U₃O₈ Powder | | Temp. |
|---|---|---|---|
| Surface Area m²/gm | Surface Area m²/gm | Calciner | Profile |
| Average: 5.6 m²/gm | Average: 6.3 m²/gm | Zone | % |
| 5.6 | 6.2 | 1 | 300-400 |
| 6.1 | 7.0 | 2 | 300-400 |
| 5.5 | 6.5 | 3 | 300-400 |
| 5.7 | 6.6 | 4 | 300-400 |
| 5.6 | 6.4 | 5 | 300-400 |
| 5.2 | 5.9 | 6 | 400-500 |
| | 6.3 | 7 | 400-500 |
| | 5.8 | 8 | 400-500 |
| | 6.3 | 9 | 300-500 |

TABLE 1B

| | UO₂ Powder | UO₂ Powder |
|---|---|---|
| | Temp. Profile | Surface Area m²/gm |
| Calciner Zone | ° C. | Average: 4.4 m²/gm |
| 1 | 600-675 | 4.6 |
| 2 | 610-700 | 4.4 |
| 3 | 610-700 | 4.9 |
| 4 | 625-700 | 4.6 |
| 5 | 625-725 | 4.5 |
| 6 | 625-700 | 4.1 |
| 7 | 625-700 | 4.4 |
| 8 | 625-700 | 4.3 |
| 9 | 430-480 | 4.0 |
| | | 4.2 |
| | | 3.9 |

In the above examples, each calciner has nine temperature zones. temperatures of zones 6-9 in the calciner 1 are important in ensuring correct surface area and sinter density properties are obtained in the final UO₂ powder. In Table 1A, the temperature in zones 6-9 is higher than that in zones 1-5. This acts to decrease the surface area of the U₃O₈ thereby achieving the desired surface area range (3.5 to 5 m²/gm) for UO₂. A higher temperature will produce a lower surface area U₃O₈ and thereby a lower surface area UO₂. In this way, by controlling the surface area of the U₃O₈ by careful control of the temperature profile of the calciner, it is possible to control the surface area of the UO₂.

The reduction step in calciner 2 is carried out at a higher temperature than for the oxidation step. The temperature is increased to about 600-725° C. along the length of the calciner, with the temperature at the end of the calciner (zone 9) dropping to about 430-480° C. At no time is the temperature allowed to exceed 800° C. to avoid sintering of the UO₂.

The increase in temperature in the reduction step results in the formation of UO₂ particles having a surface area in the region of about 3.5 to 5.0 m²/gm. The UO₂ has a high sinter density, generally about 98-99% TD, more usually in the range of 98.3 to 98.9% TD.

The UO₂ powder produced according to the present invention may be used directly in the fabrication of fuel pellets if the isotopic U²³⁵ content meets production needs. The isotopic content is determined using conventional techniques. Depending on what the desired uranium content of powder is, the UO₂ produced according to the invention may be blended with any one of “virgin” UO₂, ADU powder or additional reclaimed UO₂ powder, in proportions of up to about 50% by weight to achieve the desired uranium content.

As used herein, the term “virgin UO₂” means UO₂ obtained by the hydrolysis of uranium hexafluoride followed by defluorination, and hydrogen reduction to produce UO₂ using a number of conventional processes.

The UO₂ produced according to the process of the invention may be subjected to milling, slugging, and granulation, according to conventional techniques. This may be performed prior to mixing with virgin UO₂/ADU/reclaimed powder and may also be performed thereafter, as illustrated in FIG. 1. The resulting UO₂ powder is the pressed to form “green” fuel pellets using techniques well known in the art.

Recycle material contains a wide range of enrichments, i.e. percentage of U²³⁵ isotope. Consequently, the material may be blended to produce a homogeneous batch of material to establish an average value. A portion of this homogeneous blend is then combined with virgin UO₂ to produce a number of different enrichment blends required production.

Referring to Table 2, there is shown the effect on particle size of times and temperatures on 9 samples of uranium-containing material.

TABLE 2
Oxidation

| | | Oxidation | Oxidation | Particle | | |
|---|---|---|---|---|---|---|
| | Description | Temperature | Time | Size | | |
| Sample | Starting Material | ° C. | hrs | microns | Color | Phase |
| 1 | UO₂ Powder | | | 1.7 | Brown | UO₂ |
| | Base Case | | | 1.5 | | |
| 2 | UO₂ Powder | 376 | | 1.3 | Brown | %-U₃O₈ |
| | | 400 | 5 | | | Single |
| | | | 4 | | | |
| 3 | UO₂ Powder | 600 | | 2.1 | Green | %-U₃O₈ |
| | | 700 | 2 | | | Single |
| | | | 2 | | | |
| 4 | UO₂ Powder | 376 | | 2.7 | Black | %-U₃O₈ + |
| | | 400 | 5 | | | %-U₃O₈ |
| | | 600 | | | | |
| | | 700 | 4 | | | |
| | | 900 | | | | |
| | | | 2 | | | |
| | | | 1 | | | |
| 5 | UO₂ Powder | 1000 | | 9.1 | Black | %-U₃O₈ + |
| | | | 4 | | | U₃O₈ |
| 6 | UO₂ Powder | 1000 | | 6.6 | Black | |
| | | Milled | 4 | | | |
| | | | 30 mins | | | |
| 7 | Sintered Pellet | 375 | | 4.2 | Black | %-U₃O₈ |
| | | | 3 | | | |
| 8 | Sintered Pellet | Milled | 15 mins | | Brown | UO₂ |
| 9 | Sintered Pellet | Milled | 15 mins | | | |
| | | 376 | | | Green | %-U₃O₈ + |
| | | | 10 | | | UO₂ (OH)₂ |

As shown in Table 2, UO₂ exposed within the temperature range of 375 and 400° C. for nine hours shows a smaller particle size than the initial material. When higher temperatures are used in the region of 600-700° C., the size increases significantly, even if the oxidation time is less. The residence time in the production furnace for sintered material ranges from about 2-3 hours, averaging about 2.7 hours. In the rotary calciner/kiln, the powder in the production unit has a residence time of 90 minutes. These results indicate that temperature plays a more important role in the sintering of U₃O₈ than residence time.

The particle size in Table 2 was determined using light scattering measurements. Consequently, these measurements determine the actual size of the sintered particle which is composed of many small particles. The surface area (m² m²/gm) discussed above is inversely proportional to particle size, and is more representative of the basic particle size that has sintered or fused together to form the sintered particles measured by light scattering. Based on the results shown in FIG. 2 and Table 2, it appears that as the oxidation temperature increases, both the basic particle size and the number of particles that sinter together increase.

By careful choice of the oxidizing conditions, it is possible, according to the present invention, to minimize particle size and maximize specific surface area of the powder without causing sintering of U₃O₈ or UO₂.

Following reduction to produce the high density UO₂, the powder is milled, slugged and granulated. The UO₂ powder is then blended, if desired, to achieve the desired isotopic content. This blended UO₂ powder is incrementally added to virgin UO₂, reclaimed powder, or mixed blends of virgin UO₂ and reclaimed powder, in proportions of up to 25 wt % with sintered scrap material and up to 50 wt % with powder scrap material.

Two additional steps may if desired be performed, namely mill, slug and granulation and homogenous blending. These operations improve the ceramic quality of the powder by raising the sintered density and improving the microblending of the powder.

The invention permits improved production rates of recycled UO₂. It has been found that rejected UO₂ powder can be recycled at rates up to 60 to 80 kgs/hr using the process of the invention.

### EXAMPLES

The invention will now be further described with reference to the following examples.

### Example 1

Results of Dry Recycle Process

Oxidation of recycle sintered material at temperatures between 350° C. to 400° C. was performed according to the invention to give U₃O₈. The particles sizes were determined using a microtrac particle analyzer. This analyzer utilizes a dual system to measure both forward-scattered and side-scattered light. Particle sizes between 0.12 and 42.2 microns were obtained.

The oxidized sintered material in the form of U₃O₈ had the following particle size distribution.

TABLE

| Average Particle Size | |
|---|---|
| (Microns) | 90% less (Microns) |
| 3.5 | 7.2 |
| 4.0 | 8.3 |

Hydrogen reduction of U₃O₈ was performed in a calciner to form UO₂ at the lower temperature profile than with virgin UO₂ as shown below. The data presented below was obtained using an ADU feed. However, the process is not limited to ADU as a feed, and works with powder obtained from a nitrate process or a process that reacts UF₆ with steam (referred to as the “dry conversion process”).

TABLE

| | ADU Feed | Dry Recycle Feed |
|---|---|---|
| Zone | Temperature ° C. | Temperature ° C. |
| 1 | 750 | 375 |
| 2 | 765 | 375 |
| 3 | 750 | 400 |
| 4 | 770 | 500 |
| 5 | 770 | 550 |
| 6 | 750 | 635 |
| 7 | 700 | 550 |
| 8 | 700 | 500 |

TABLE

| Average Particle Size | 90% Less than |
|---|---|
| (Microns) | (Microns) |
| 5.4 | 9.8 |
| 4.7 | 8.8 |
| 5.2 | 9.4 |
| 5.1 | 10.0 |

The UO₂ particles are larger than the U₃O₈ particles, indicating some sintering of U₃O₈ occurred during hydrogen reduction calcination Process, and also prior to complete reduction to UO₂. Blending of the reclaimed material in different proportions with virgin ADU material provides good microstructure and sinter density.

### Example 2

UO₂ powder produced according to the invention was added to ADU, reclaimed (UCON), and crossblends of ADU and reclaimed (UCON) powder. UCON powder is a powder produced by oxidizing rejected material and dissolving in nitric acid, followed by ADU precipitation (see U.S. Pat. No. 5,514,06 incorporated herein by reference). UCON powder also includes scrap material that is oxidized, dissolved in nitric acid, purified by solvent extraction to produce uranyl nitrate, followed by ADU precipitation. Solvent extraction removes a significant amount of cation and anion impurities.

The following proportions were investigated:

1, 2, 3, 5, 10, 20 and 25 wt %.

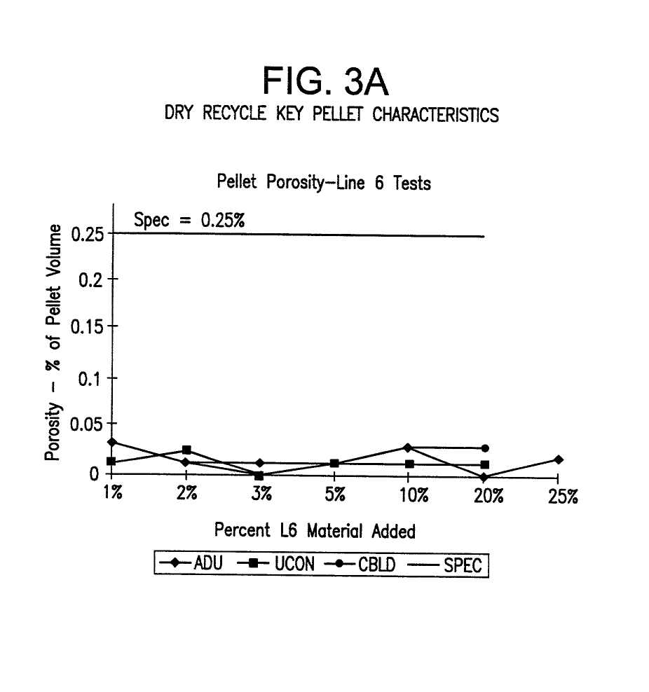

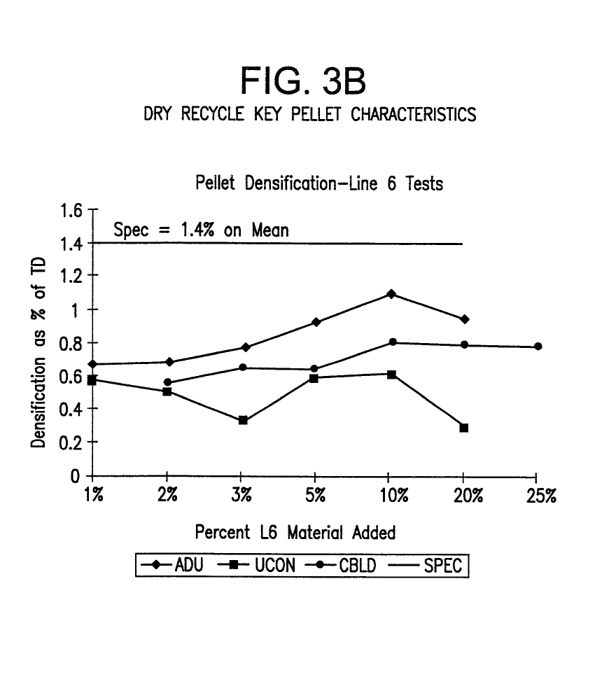

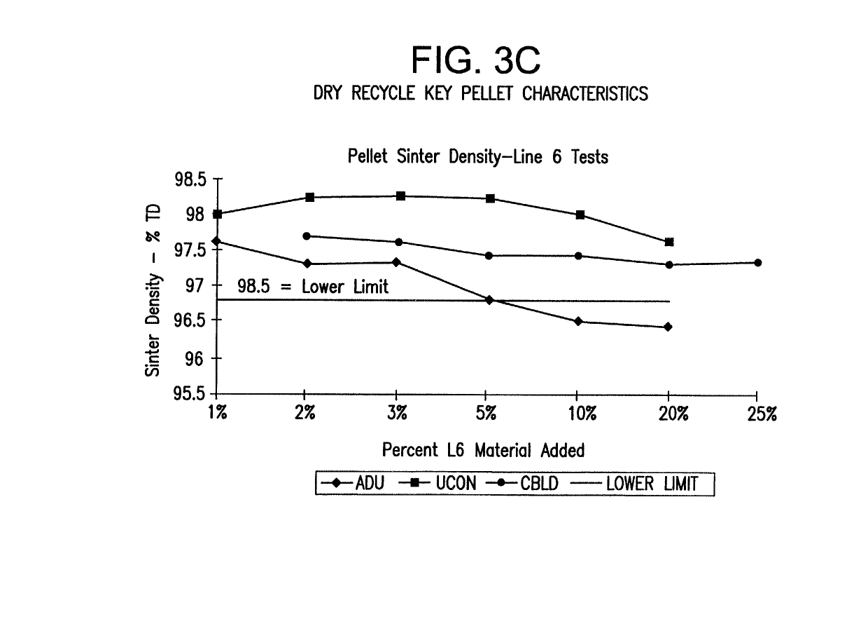

FIG. 3 shows the results. It will be seen that all percentages gave porosities that were well below the specification of 0.25%. The pellet densification was also well below the specification requirements. Initial tests using dry conversion powder also gave good results. Reclaim (UCON) and crossblends of ADU and reclaim (UCON) met the sinter density specification with up to 25% of the dry recycled powder. ADU powder was limited to 3% of the recycled material.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for producing high sinter density UO₂ powder from uranium-containing scrap material, comprising the steps of:
(a) oxidizing uranium-containing scrap material at low temperature to produce U₃O₈ powder;
(b) reducing said U₃O₈ powder at a higher temperature than in step (a) and less than about to 800° C. to produce reclaimed UO₂ having high sinter density and high surface area.

2. A process according to claim 1, wherein said uranium-containing scrap material is in particulate form in which the particles have a surface area of about 5.0-6.5 m²/gm.

3. A process according to claim 1, wherein said low temperature in said oxidizing step is in the range of 300-500° C.

4. A process according to claim 1, wherein said U₃O₈ powder has a surface area of about 5.8-7.5 m²/gm.

5. A process according to claim 1, wherein said oxidation is carried out in a furnace and air or oxygen is passed through the furnace in contact with said scrap UO₂.

6. A process according to claim 1, wherein said higher temperature in said reducing step is about 600-725° C.

7. A process according to claim 1, wherein said oxidizing step is carried out in a furnace.

8. A process according to claim 1, wherein said reducing step is carried out passing hydrogen gas through said furnace in contact with said U₃O₈.

9. A process according to claim 1, wherein said reducing step is carried out in a different furnace than said oxidizing step.

10. A process according to claim 8, wherein nitrogen is mixed with said hydrogen.

11. A process according to claim 10, wherein said nitrogen is present in an amount of 5 to 25% by volume.

12. A process according to claim 1, wherein said UO₂ produced by reducing said U₃O₈ has a surface area of about 3.5-5.0 m²/gm.

13. A process according to claim 12, wherein said UO₂ produced by reducing said U₃O₈ has a sinter density of about 98-99% TD.

14. A process according to claim 1, and further comprising subjecting said UO₂ obtained from the reduction of U₃O₈ to milling, slugging and granulation to produce granulated UO₂.

15. A process according to claim 12, wherein said granulated UO₂ is mixed with virgin UO₂ to produce UO₂ having a predetermined isotopic content.

16. A composition comprising high sinter density UO₂ produced according to the process of the invention and virgin UO₂.

17. A composition comprising U₃O₈ produced according to the oxidizing step of claim 1 in admixture with virgin UO₂.

18. High sinter density UO₂ produced by the process of claim 1.

19. Pellets containing high sinter density UO₂ produced by the process of claim 1.
